(19) United States
(12) Patent Application Publication
(10) Pub. No.: US 2020/0058319 A1
(43) Pub. Date: Feb. 20, 2020

(54) INFORMATION PROCESSING DEVICE, ELECTRONIC APPARATUS, CONTROL METHOD, AND STORAGE MEDIUM

(71) Applicant: SHARP KABUSHIKI KAISHA, Sakai City, Osaka (JP)

(72) Inventors: YOSHIO SATOH, Sakai City, Osaka (JP); YOSHIRO ISHIKAWA, Sakai City, Osaka (JP)

(21) Appl. No.: 16/610,252

(22) PCT Filed: Mar. 27, 2018
(86) PCT No.: PCT/JP2018/012384

§ 371 Date: Nov. 1, 2019

(30) Foreign Application Priority Data
May 11, 2017 (JP) 2017-094942

(51) Int. Cl. G10L 25/84; G10L 15/22; G10L 15/20

(52) U.S. Cl. CPC G10L 25/84; G10L 2015/223; G10L 15/20; G10L 15/22

(57) ABSTRACT

A response is prevented from being made by a malfunction. A control section (10) includes: a speech sound obtaining section (11) configured to distinctively obtain detected sounds from respective microphones (30), the detected sounds being ones that have been detected by the respective microphones (30); a noise determining section (14) configured to determine whether or not each of the detected sounds is a noise and configured to, in a case where a content of a speech is not recognized from a detected sound, determine that the detected sound is a noise; and a detection control section (17) configured to, in a case where the noise determining section (14) determines that any of the detected sounds is a noise, control at least one of the microphones (30) to stop detecting a sound.

### TECHNICAL FIELD

The present invention relates to, for example, an information processing device which recognizes a content of a speech and causes an output section to output a response corresponding to the content of the speech.

### BACKGROUND ART

In recent years, various information processing devices have been developed which detect speeches with use of sensors, microphones, or the like and output responses (for example, a given action or message) corresponding to contents of the speeches.

As a technique related to such an information processing device, a technique of preventing a malfunction from occurring in response to a sound other than a user's speech is disclosed. For example, Patent Literature 1 discloses an operation device which starts to accept an input of a speech sound in a case where the operation device detects a given cue from a user and which carries out a given action, for example, operates an air conditioner in a case where meaning of an inputted speech sound matches a command registered in advance.

### CITATION LIST

### Patent Literature

### Patent Literature 1

Japanese Patent Application Publication Tokukai No. 2007-121579 (published on May 17, 2007)

### SUMMARY OF INVENTION

### Technical Problem

However, in a case where (i) the technique of the operation device disclosed in Patent Literature 1 is employed and (ii) the technique is arranged such that more commands, made by speech sounds, can be accepted, there is a possibility that an unexpected malfunction will occur.

For example, an interactive robot or the like which interacts with a user results in making a wide variety of responses to a great many types of contents of speeches. As such, as it is intended to cause an interactive robot or the like to make a more detailed response depending on a content of a speech, it is more likely that the robot or the like falsely detects an environmental sound, such as a sound of a television program, as a user's speech.

An aspect of the present invention has been made in view of the above problem, and an object of the aspect of the present invention is to realize an information processing device and the like each of which prevents a response from being made by a malfunction.

### Solution to Problem

In order to attain the above object, an information processing device in accordance with an aspect of the present invention is an information processing device which recognizes a content of a speech and causes an output section to output a response corresponding to the content of the speech, including: a speech sound obtaining section configured to distinctively obtain detected sounds from respective microphones, the detected sounds being ones that have been detected by the respective microphones; a noise determining section configured to determine whether or not each of the detected sounds is a noise and configured to, in a case where a content of a speech is not recognized from a detected sound, determine that the detected sound is a noise; and a detection control section configured to, in a case where the noise determining section determines that any of the detected sounds is a noise, control at least one of the microphones to stop detecting a sound.

In order to attain the above object, a method of controlling an information processing device in accordance with an aspect of the present invention is a method of controlling an information processing device which recognizes a content of a speech and causes an output section to output a response corresponding to the content of the speech, the method including the steps of: (A) distinctively obtaining detected sounds from respective microphones, the detected sounds being ones that have been detected by the respective microphones; (B) determining whether or not each of the detected sounds is a noise and, in a case where a content of a speech is not recognized from a detected sound, determining that the detected sound is a noise; and (C) in a case where it is determined, in the step (B) that any of the detected sounds is a noise, controlling at least one of the microphones to stop detecting a sound.

### Advantageous Effects of Invention

According to an aspect of the present invention, it is possible to prevent a response from being made by a malfunction.

### BRIEF DESCRIPTION OF DRAWINGS

FIG. 1 is a block diagram illustrating a configuration of a main part of an interactive robot in accordance with Embodiment 1 of the present invention.

FIG. 2 illustrates an example operation conducted by the interactive robot.

FIG. 3 is a flowchart illustrating an example flow of a process carried out by the interactive robot.

FIG. 4 is a block diagram illustrating a configuration of a main part of an interactive robot in accordance with Embodiment 2 of the present invention.

FIG. 5 illustrates an example operation conducted by the interactive robot.

FIG. 6 is a flowchart illustrating an example flow of a process carried out by the interactive robot.

### DESCRIPTION OF EMBODIMENTS

### Embodiment 1

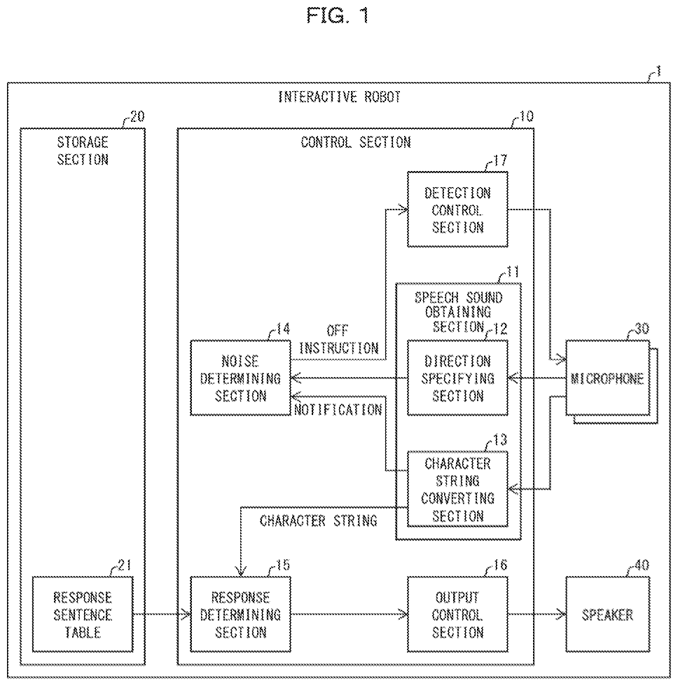

The following description will discuss Embodiment 1 of the present disclosure with reference to FIGS. 1 through 3. FIG. 1 is a block diagram illustrating a configuration of a main part of an interactive robot 1 in accordance with Embodiment 1. The interactive robot 1 is an electronic apparatus which recognizes a content of a user's speech and outputs a response corresponding to the content of the speech. Note, here, that the term response means a reaction of the interactive robot 1 to a speech and the reaction is made by a speech sound, an action, light, or a combination thereof. In Embodiment 1, a case where the interactive robot outputs a response to a content of a speech by a speech sound through a speaker 40 (later described) will be described as example. As illustrated in FIG. 1, the interactive robot 1 includes a storage section 20, a microphone 30, the speaker (output section) 40, and a control section (information processing device) 10.

The storage section 20 is a memory in which data necessary for the control section 10 to carry out a process is stored. The storage section 20 at least includes a response sentence table 21. The response sentence table 21 is a data table in which a given sentence or keyword and a content of a response are stored in a state where the content of the response is associated with the given sentence or keyword. In Embodiment 1, a character string of a message, to be an answer to the sentence or keyword, is stored as a content of a response.

The microphone 30 is an input device which detects a sound. A type of the microphone 30 is not limited to any particular one. Note, however, that the microphone 30 has such detection accuracy and directivity that allow a direction specifying section 12 (later described) to specify a direction of a detected sound. The microphone 30 is controlled, by a detection control section 17 (later described), to start to detect a sound and stop detecting a sound. The interactive robot 1 includes microphones 30. It is desirable that the microphones 30 be provided to the interactive robot 1 in such a manner that the microphones 30 face in respective different directions. This allows an improvement in accuracy with which the direction specifying section 12 (later described) specifies a direction of a detected sound.

The speaker 40 outputs a message, which is a content of a response, by a speech sound under control of an output control section 16 (later described). The interactive robot 1 can include a plurality of speakers 40.

The control section 10 is a central processing unit (CPU) which integrally controls the interactive robot 1. The control section 10 includes, as function blocks, speech sound obtaining section 11, a noise determining section 14, a response determining section 15, the output control section 16, and the detection control section 17.

The speech sound obtaining section 11 obtains sounds detected by the respective microphones 30. The speech sound obtaining section 11 distinctively obtains such detected sounds from the respective microphones 30. Further, the speech sound obtaining section 11 obtains the sounds, detected by the respective microphones 30, in such a manner that the speech sound obtaining section 11 divides each of the sounds at any length and obtains the each of the sounds thus divided over a plurality of times. The speech sound obtaining section 11 includes the direction specifying section 12 and a character string converting section 13.

The direction specifying section 12 specifies a direction in which each of sounds detected by the respective microphones 30 has been uttered. The direction specifying section 12 can comprehensively specify, in accordance with the sounds detected by the respective microphones 30, directions in which the respective sounds have been uttered. The direction specifying section 12 transmits, to the noise determining section 14, information indicative of such a specified direction of each of the sounds.

The character string converting section 13 converts, into a character string, each of sounds detected by the respective microphones 30. The character string converting section 13 transmits the character string thus converted to the response determining section 15. Note that in a case where it is not possible for the character string converting section 13 to convert a detected sound into a character string because, for example, the detected sound is not a language, the character string converting section 13 notifies the noise determining section 14 that the detected sound is inconvertible.

The character string converting section 13 determines whether or not each of detected sounds is convertible into a character string. Then, in a case where it is possible for the character string converting section 13 to convert a detected sound into a character string, the character string converting section 13 transmits the character string to the response determining section 15. In a case where it is not possible for the character string converting section 13 to convert a detected sound into a character string, the character string converting section 13 transmits, to the noise determining section 14, a notification that the detected sound is inconvertible. Alternatively, the character string converting section 13 can be configured as follows. That is, the character string converting section 13 selects any one (for example, the loudest one) of a plurality of detected sounds, and determines whether or not the any one of the plurality of detected sounds is convertible into a character string. In a case where it is possible for the character string converting section 13 to convert the any one of the plurality of detected sounds into a character string, the character string converting section 13 transmits the character string to the response determining section 15. In a case where it is not possible for the character string converting section 13 to convert the any one of the plurality of detected sounds into a character string, the character string converting section 13 transmits, to the noise determining section 14, a notification that the any one of the plurality of detected sounds is inconvertible.

The noise determining section 14 determines whether or not each or any one of sounds detected by the respective microphones 30 is a noise. In a case where the noise determining section 14 receives, from the character string converting section 13, a notification that a detected sound is inconvertible, that is, in a case where it is not possible for the character string converting section 13 to recognize a content of a speech, the noise determining section 14 determines that the detected sound, which has been detected by a corresponding one of the microphones 30, is a noise. In a case where the noise determining section 14 determines that a detected sound is a noise, the noise determining section 14 transmits, to the detection control section 17, an instruction to cause at least one of the microphones 30 to stop detecting a sound (OFF instruction).

Note that in a case where the noise determining section 14 determines that a detected sound is a noise, the noise determining section 14 can determine at least one of the microphones 30, which at least one is to be caused to stop detecting a sound, on the basis of (i) information which has been received from the direction specifying section 12 and which indicates a direction of each of detected sounds and (ii) arrangement of the microphones 30 in the interactive robot 1 and directivity of each of the microphones 30. In this case, the noise determining section 14 can specify, in an OFF instruction, the at least one of the microphones 30 which at least one is to be stopped.

Note that the noise determining section 14 can be configured such that, in a case where the noise determining section 14 receives, a given number of times (for example, twice) in succession within a given time period, notifications each indicating that a sound detected by any one of the microphones 30 is inconvertible, the noise determining section 14 determines that those sounds detected by any one(s) of the microphones 30 are each a noise. In this case, the noise determining section 14 does not need to transmit an OFF instruction, at the first time point at which it is not possible for the character string converting section 13 to recognize a content of a speech.

The response determining section 15 determines, in accordance with an instruction to respond (hereinafter, referred to as a response instruction), a response to a character string. In a case where the response determining section 15 receives a character string from the character string converting section 13, the response determining section 15 searches the response sentence table 21 in the storage section 20 for a content of a response (message) which content corresponds to a sentence or a keyword included in the character string. The response determining section 15 determines, as an output message, at least one message out of messages obtained as a result of such a search, and transmits the at least one message to the output control section 16.

The output control section 16 controls the speaker to output an output message received from the response determining section 15.

The detection control section 17 controls, in accordance with an OFF instruction received from the noise determining section 14, at least one of the microphones 30, which at least one is specified by the noise determining section 14 in the OFF instruction, to stop detecting a sound. Note that after a given time period has elapsed or in a case where the detection control section 17 receives, from the noise determining section 14, an instruction to cause the at least one of the microphones 30 to resume detecting a sound (ON instruction), the detection control section 17 can control the at least one of the microphones 30 to resume detecting a sound.

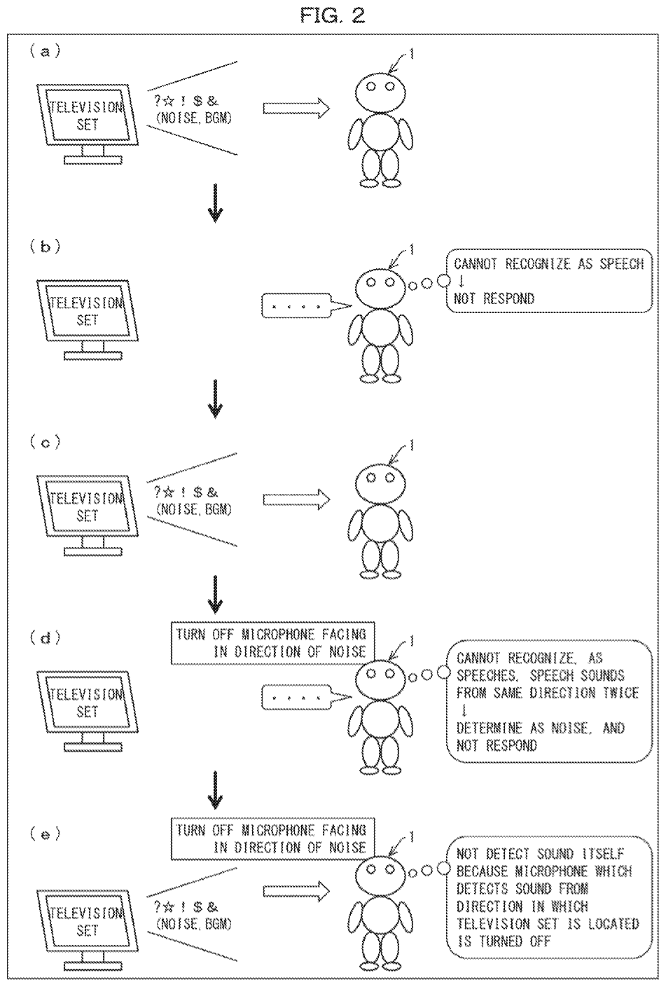

Next, specific operation conducted by the interactive robot 1 will be described with reference to FIG. 2. FIG. 2 illustrates an example operation conducted by the interactive robot 1. In FIG. 2, as an example, a case will be described where (i) the microphones 30 are provided on right and left sides, respectively, of a housing of the interactive robot 1 and (ii) a right microphone 30, out of the microphones 30, detects a noise or a background music (BGM) of a television set. The following description is based on the premise that, in a case where it is not possible for the character string converting section 13 to recognize contents of speeches twice in succession, the noise determining section 14 determines that detected sounds are each a noise.

In a case where the right microphone 30 of the interactive robot 1 detects a noise or a BGM of a television set ((a) of FIG. 2), the speech sound obtaining section 11 of the control section 10 obtains the noise or the BGM, and the character string converting section 13 attempts to convert such a detected sound into character string. Since it is not possible for the character string converting section 13 to recognize the noise or the BGM as a language, the character string converting section 13 notifies the noise determining section 14 that the detected sound is inconvertible. In this case, since the response determining section 15 does not obtain a character string, the response determining section 15 does not determine a response. Thus, the interactive robot 1 does not respond ((b) of FIG. 2).

Next, it is assumed that the right microphone 30 detects a noise or a BGM of the television set again ((c) of FIG. 2). In this case, the character string converting section 13 of the speech sound obtaining section 11 notifies again the noise determining section 14 and the response determining section 15 that such a detected sound is inconvertible. Since it has not been possible for the character string converting section 13 to recognize contents of speeches twice in succession, the noise determining section 14 determines that sounds detected by an identical one of the microphones 30 are each a noise. The noise determining section 14 identifies at least one of the microphones 30 which at least one faces in a direction in which the detected sound has been uttered (in this example, the right microphone 30), on the basis of information which has been received from the direction specifying section 12 and which indicates the direction. The noise determining section 14 transmits an OFF instruction, in which the light microphone 30 thus identified is specified, to the detection control section 17. The detection control section 17 controls the right microphone 30 to be stopped ((d) of FIG. 2).

From then on, since the right microphone 30, which detects a sound in a direction in which a television set is located, is stopped, the interactive robot 1 is in a state of not detecting a sound itself from the television set ((e) of FIG. 2).

Note that, in a case where the noise determining section 14 transmits a response instruction to the response determining section 15 in response to a sound detected by a left microphone 30 or in a case where a given time period has elapsed since transmission of an OFF instruction, the noise determining section 14 can cancel the OFF instruction. Alternatively, in a case where the noise determining section 14 transmits a response instruction to the response determining section 15 in response to a sound detected by the left microphone 30 or in a case where a given time period has elapsed since transmission of an. OFF instruction, the noise determining section 14 can transmit an ON instruction for causing the right microphone 30, which has been stopped in accordance with the OFF instruction, to resume detecting a sound. Then, the detection control section 17 can control, in accordance with cancellation of the OFF instruction or in accordance with the ON instruction, the right microphone 30 to resume detecting a sound.

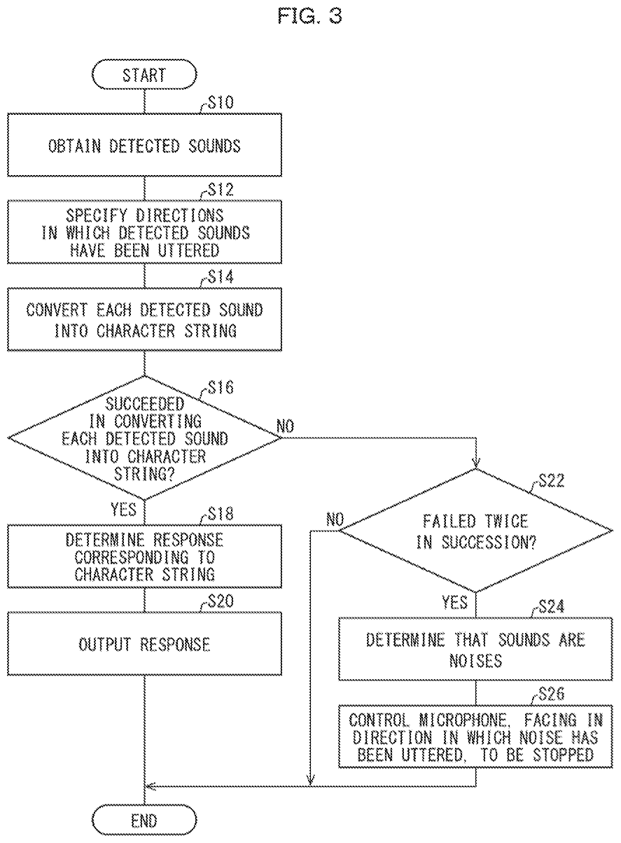

Finally, a flow of a process carried out by the interactive robot 1 will be described with reference to FIG. 3. FIG. 3 is a flowchart illustrating an example flow of a process carried out by the interactive robot 1. In a case where the microphones 30 detect sounds, the speech sound obtaining section 11 distinctively obtains such detected sounds (S10, sound obtaining step). The speech sound obtaining section 11 specifies, at the direction specifying section 12, directions in which the respective detected sounds have been uttered (S12), and transmits information indicative of the directions to the noise determining section 14. The character string converting section 13 converts each of the detected sounds into a character string (S14).

Here, in a case where the character string converting section 13 succeeds in converting each of the detected sounds into a character string (YES in S16), the response determining section 15 receives the character string from the character string converting section 13, and determines a response corresponding to the character string (S18). The output control section 16 controls the speaker 40 to output the response thus determined, and the speaker 40 outputs the response by a speech sound (S20).

In a case where the character string converting section 13 fails in converting a detected sound into a character string (NO in S16), the character string converting section 13 notifies the noise determining section 14 that the detected sound is inconvertible. In a case where the noise determining section 14 receives such a notification, the noise determining section 14 determines whether or not to have received such notifications twice in succession in regard to sounds detected by an identical one of the microphones 30 (S22). In case where the notification is the first one of successive notifications (NO in S22), the noise determining section 14 stands by without transmitting an OFF instruction. In a case where the notification is the second one of the successive notifications (YES in S22), the noise determining section 14 determines that detected sounds are each a noise (S24, noise determining step), and specifies at least one of the microphones 30 which at least one faces in a direction in which the noise has been uttered, on the basis of information which has been received from the direction specifying section 12 and which indicates the direction. Subsequently, the noise determining section 14 instructs the detection control section 17 to control a specified one of the microphones 30 to be stopped, and the detection control section 17 controls the specified one of the microphones 30 to be stopped (S26, detection control step).

Note that a process in S12 and a process in S14 can be carried out in reverse order or can be alternatively carried out simultaneously. Note also that the process in S22 is not essential. That is, in a case where the noise determining section 14 receives, from the character string converting section 13, a notification that a detected sound is inconvertible, the noise determining section 14 can carry out a process in S24 and a process in S26 even in a case where the notification is the first notification.

According to the above process, it is possible for the interactive robot 1 to determine whether or not a sound detected by each of the microphones 30 is a noise. Specifically, on the basis of whether or not a sound detected by each of the microphones 30 is a sound that is recognized as a language, it is possible to determine whether or not the sound is a noise. This allows the interactive robot 1 to determine whether or not a detected sound is a speech which a user intends. Therefore, it is possible to prevent a malfunction of falsely responding to a noise.

Furthermore, since the interactive robot specifies a direction in which a noise has been uttered, and stops at least one of the microphones 30 which at least one facies in the detection, it is possible to reduce detection of a noise after that. Therefore, it is possible to omit an unnecessary process, such as a determining process or operation, which is carried out in a case where a detected sound is a noise. This allows a reduction in load imposed on the interactive robot 1, and allows a reduction in unnecessarily consumed electric power. Thus, it is possible to prolong an operating time period of the interactive robot 1.

### Embodiment 2

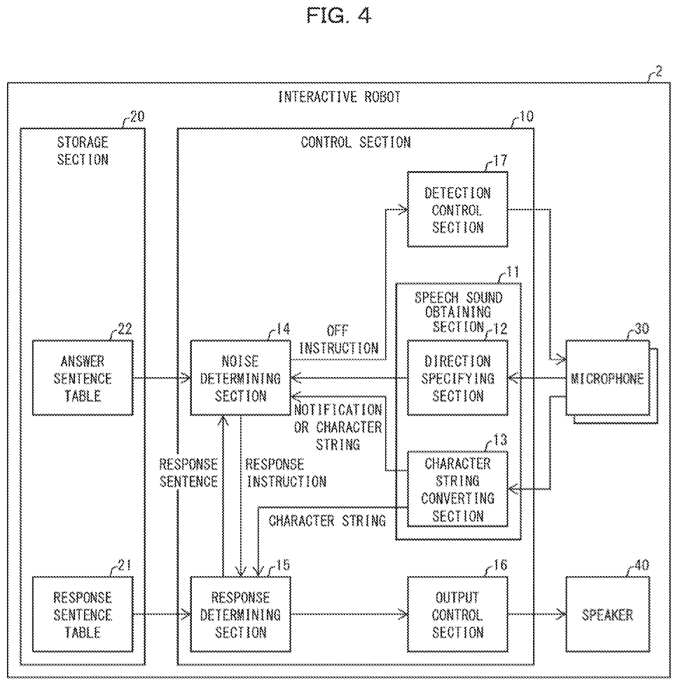

The following description will discuss Embodiment 2 of the present disclosure with reference to FIGS. 4 through 6. Note that, for convenience, a member having a function identical to that of a member described in Embodiment 1 will be given an identical reference sign and will not be described below.

FIG. 4 is a block diagram illustrating a configuration of a main part of an interactive robot 2 in accordance with Embodiment 2. The interactive robot 2 is different from the interactive robot 1 in accordance with Embodiment 1 in that, according to the interactive robot 2, an answer sentence table 22 is stored in a storage section 20.

The answer sentence table 22 is information in which a character string, indicative of a content of a user's answer, is associated with a response. Note that the response on the answer sentence table 22 is identical to that stored on a response sentence table 21.

A character string converting section 13 in accordance with Embodiment 2 transmits, also to a noise determining section 14, a character string converted from a detected sound. A response determining section 15 in accordance with Embodiment 2 transmits a determined response to the noise determining section 14.

The noise determining section 14 in accordance with Embodiment 2 stores a response received from the response determining section 15. Note that, in a case where a given time period has elapsed, the noise determining section 14 can delete the response stored therein. In a case where the noise determining section 14 receives a character string from the character string converting section 13, the noise determining section 14 refers to the answer sentence table 22, and determines whether or not at least part of the character string matches a character string which is stored on the answer sentence table 22 and which is indicative of a content of a user's answer. That is, the noise determining section 14 determines whether or not, on the answer sentence table 22, at least part of the character string obtained from the character string converting section 13 is associated with the response having been obtained from the response determining section 15. In other words, the noise determining section 14 determines whether or not a content of a speech indicated by an obtained character string, that is, a detected sound is a content which is expected as an answer to a content of the response having been outputted by a speaker 40.

In a case where, on the answer sentence table 22, at least part of the obtained character string is associated with the response, that is, in a case where the content of the speech is an expected answer, the noise determining section 14 transmits, to the response determining section 15, an instruction indicative of permission for making a response. Upon receipt of the instruction, the response determining section 15 determines a response.

On the other hand, in a case where, on the answer sentence table 22, any part of the obtained character string is not associated with the response, that is, in a case where the content of the speech is not an expected answer, the noise determining section 14 transmits an OFF instruction to a detection control section 17. In this case, the noise determining section 14 does not transmit, to the response determining section 15, an instruction indicative of permission for making a response. As a result, the interactive robot 2 does not respond.

Note that, in a case where the noise determining section 14 obtains a character string in a state where the noise determining section 14 does not store a response transmitted from the response determining section 15, the noise determining section 14 can transmit, to the response determining section 15, an instruction indicative of permission for making a response.

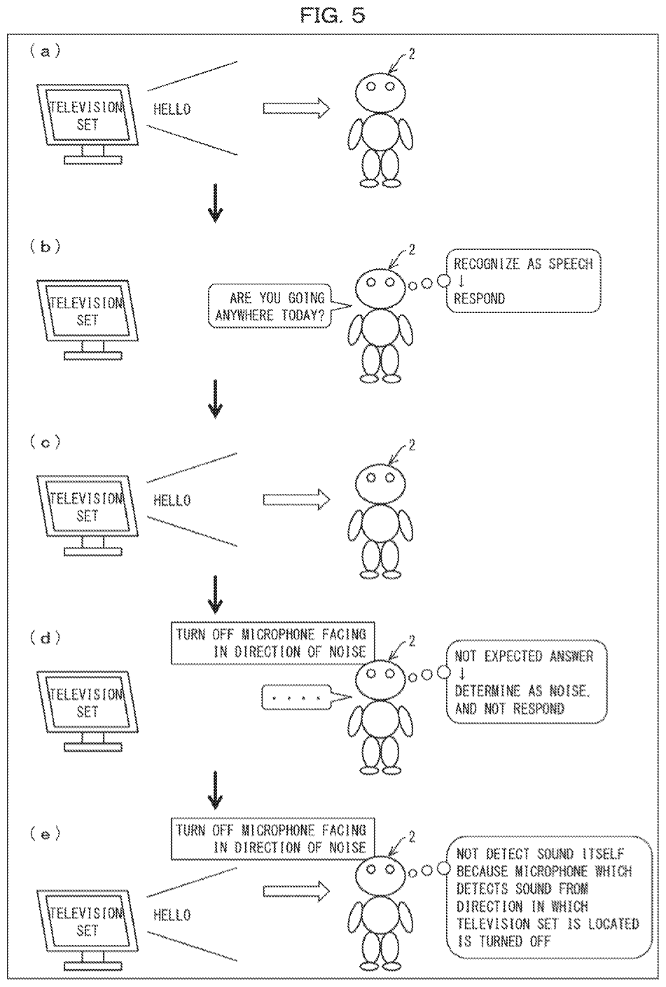

Next, specific operation conducted by the interactive robot 2 will be described with reference to FIG. 5. FIG. 5 illustrates an example operation conducted by the interactive robot 2. In FIG. 5, as an example, a case will be described where microphones 30 are provided on right and left sides, respectively, of a housing of the interactive robot 2 and a right microphone 30, out of the microphones 30, detects a speech sound of a television program.

In a case where the right microphone 30 detects a speech sound “Hello” of a television program ((a) of FIG. 5), a speech sound obtaining section 11 of a control section 10 obtains the speech sound, and the character string converting section 13 attempts to convert such a detected sound into a character string. Unlike the example illustrated in FIG. 2, since the speech sound “Hello” of the television program can be recognized as a language, the character string converting section 13 converts the speech sound into a character string. The character string converting section 13 notifies the noise determining section 14 and the response determining section 15 of the character string thus converted. In a case where the noise determining section 14 receives the character string in a state where the noise determining section 14 does not store a response transmitted from the response determining section 15, the noise determining section 14 transmits, to the response determining section 15, an instruction indicative of permission for making a response. Upon receipt of the instruction, the response determining section 15 determines a response, and an output control section 16 controls the speaker 40 to output the response according to the example illustrated in FIG. 5, a message “Are you going anywhere today?”) ((b) of FIG. 5). The response determining section 15 then transmits, to the noise determining section 14, the response thus outputted.

Next, it is assumed. that the right microphone 30 detects a speech sound “Hello” of the television program again ((c) of FIG. 5). Also in this case, the character string converting section 13 transmits a character string to the noise determining section 14 and the response determining section 15.

The noise determining section 14 determines whether or not, on the answer sentence table 22, at least part of the character string thus received is associated with the response stored. In a case where at least part of the character string is associated with the response, the noise determining section 14 transmits, to the response determining section 15, an instruction indicative of permission for making a response, as in last time. In a case where any part of the character string is not associated with the response, the noise determining section 14 determines that the character string received does not indicate a content of a user's answer which content is expected. In this case, the noise determining section 14 determines that the character string, that is, a detected sound is a noise. In this case, similarly to the interactive robot 1 in accordance with Embodiment 1, the noise determining section 14 transmits an OFF instruction, in which the right microphone 30 is specified, to the detection control section 17. Also in this case, since an instruction indicative of permission for making a response is not transmitted to the response determining section , the interactive robot 2 does not respond ((b) of FIG. 5).

From then on, since the right microphone 30, which detects a sound in a direction in which a television set is located, is stopped, the interactive robot 2 is in a state of not detecting a sound itself from the television set ((e) of FIG. 5).

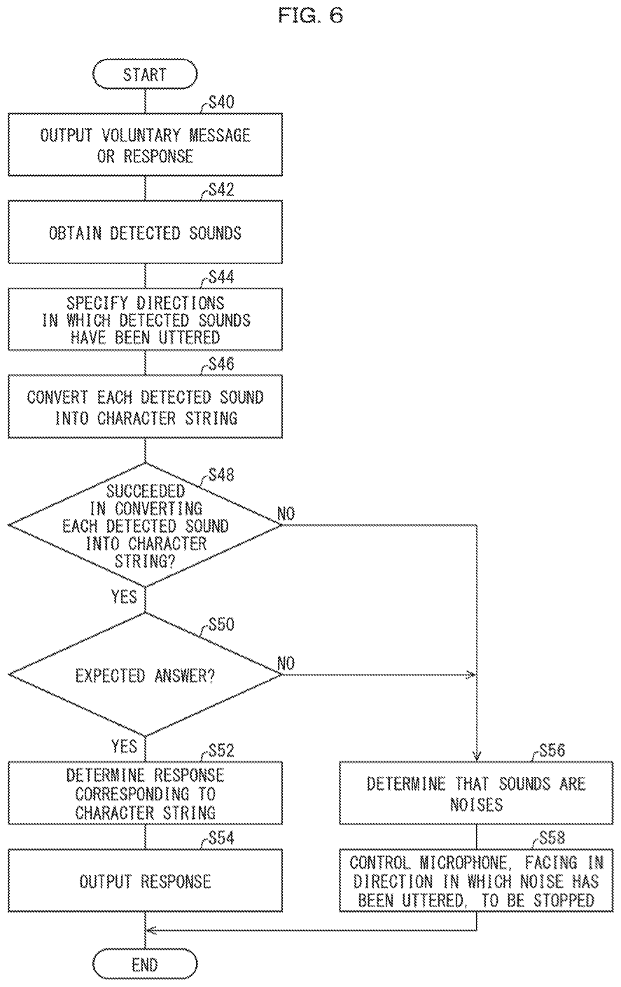

Finally, a flow of a process carried out by the interactive robot 2 will be described with reference to FIG. 6. FIG. 6 is a flowchart illustrating an example flow of a process carried out by the interactive robot 2.

The interactive robot 2 outputs a response voluntarily or in response to a user's speech (S40). In so doing, the response determining section 15 transmits the response (or voluntary message), which the response determining section 15 has determined, to the noise determining section 14. Note that a flow of outputting the response here is similar to a flow of S10 through S14, YES in S16, and S18 through S20 in FIG. 3.

Thereafter, as in S10 through S14 in FIG. 3, the interactive robot 2 obtains detected sounds (S42, sound obtaining step), specifies directions in which the respective detected sounds have been uttered (S44), and converts each of the detected sounds into a character string (S46). In a case where each of the detected sounds is successfully converted into a character string (YES, in S18), the character string converting section 13 transmits the character string to the noise determining section 14 and the response determining section 15. The noise determining section 14 determines whether or not a content of a speech indicated by the character string is an answer expected from the response or the voluntary message having been made by the interactive robot 2, in accordance with (i) the response having been transmitted from the response determining section 15, (ii) the character string received from the character string converting section 13, and (iii) the answer sentence table 22 (S50).

In a case where the content of the speech indicated by the character string is an expected answer (YES in S50), the noise determining section 14 transmits, to the response determining section 15, an instruction indicative of permission for making a response. The response determining section 15 then determines a response as in S18 in FIG. 3 (S52), and the speaker 40 outputs the response under control of the output control section 16 as in S20 in FIG. 3 (S54).

On the other hand, in a case where the content the speech indicated by the character string is not an expected answer (NO in S50), the noise determining section 14 determines that a detected sound converted into the character string is a noise (S56, noise determining step). In this case, as in S26 in FIG. 3, the noise determining section 14 instructs the detection control section 17 to control a corresponding one of the microphones 30 to be stopped, and the detection control section 17 controls the corresponding one of the microphones 30 to be stopped (S58, detection control step).

Note that, also in Embodiment 2, a process in S22 in FIG. 3 can be carried out between a process in S48 and a process in S56 or between a process in S50 and the process in S56. That is, in a case where the noise determining section 14 receives, twice in succession, notifications each indicating that a sound detected by an identical one of the microphones 30 is inconvertible, the noise determining section 14 can determine that those sounds are each a noise. Further, in a case where expected answers have not been obtained twice in succession, the noise determining section 14 can determine that detected sounds are each a noise.

According to the above process, it is possible for the interactive robot 2 to determine whether or not a sound detected by each of the microphones 30 is a noise. Specifically, on the basis of whether or not a sound detected by each of the microphones 30 is a reaction to a response (or voluntary message) which the interactive robot 2 has uttered, the interactive robot 2 determines whether or not the sound is a noise. This allows the interactive robot 2 to determine whether or not a detected sound is a speech which a user intends. Therefore, it is possible to prevent a malfunction of falsely responding to a noise.

Furthermore, since the interactive robot specifies a direction in which a noise has been uttered, and stops at least one of the microphones 30 which at least one facies in the detection, it is possible to reduce detection of a noise after that. Therefore, it is possible to omit an unnecessary process, such as a determining process or operation, which is carried out in a case where a detected sound is a noise. This allows a reduction in load imposed on the interactive robot 2, and allows a reduction in unnecessarily consumed electric power. Thus, it is possible to prolong an operating time period of the interactive robot 2.

[Variation]

According to Embodiments 1 and 2, the control section 10 is integrated with the storage section 20, the microphones 30, and the speaker 40 in each of the interactive robots 1 and 2. However, the control section 10, the storage section 20, the microphones 30, and the speaker 40 can be independent devices. These devices can be connected to each other by wire or wireless communication.

For example, the interactive robots 1 and 2 can each include the microphones 30 and the speaker 40, and a server different from the interactive robots 1 and 2 can include the control section 10 and the storage section 20. In this case, the interactive robots 1 and 2 can each transmit, to the server, sounds detected by the respective microphones 30, and receive an instruction and/or control from the server in regard to stop and start of detection of a sound by any of the microphones 30 and output by the speaker 40.

Moreover, the present disclosure can be applied to apparatuses other than the interactive robots 1 and 2. For example, various configurations in accordance with the present disclosure can be realized in smartphones, household electrical appliances, personal computers, and the like.

Furthermore, the interactive robots 1 and 2 can each show a response by methods other than output of a speech sound. For example, information specifying, as a response, a given action (gesture or the like) of the interactive robots 1 and 2 can be stored on the response sentence table 21 in advance. The response determining section 15 can determine, as a response, the given action specified by the information, and the output control section 16 controls a motor or the like of the interactive robots 1 and 2 so that the interactive robots 1 and 2 show the action, that is, the response to a user.

[Software Implementation Example]

Control blocks of the control section 10 can be realized by a logic circuit (hardware) provided in an integrated circuit (IC chip) or the like or can be alternatively realized by software with use of a central processing unit (CPU).

In the latter case, the control section 10 includes: a CPU that executes instructions of a program that is software realizing the foregoing functions; a read only memory (ROM) or a storage device (each referred to as a “storage medium”) in which the program and various kinds of data are stored so as to be readable b a computer (or a CPU); and a random access memory (RAM) in which the program is loaded. The object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

Aspects of the present invention can also be expressed as follows:

An information processing device (control section 10) in accordance with a first aspect of the present invention is an information processing device which recognizes a content of a speech and causes an output section (speaker 40) to output a response corresponding to the content of the speech, including: a speech sound obtaining section (speech sound obtaining section 11) configured to distinctively obtain detected sounds from respective microphones (microphones 30), the detected sounds being ones that have been detected by the respective microphones; a noise determining section (noise determining section 14) configured to determine whether or not each of the detected sounds is a noise and configured to, in a case where a content of a speech is not recognized from a detected sound, determine that the detected sound is a noise; and a detection control section (detection control section 17) configured to, in a case where the noise determining section determines that any of the detected sounds is a noise, control at least one of the microphones to stop detecting a sound.

According to the above process, it is possible for the information processing device to determine whether or not a sound detected by each of the microphones is a noise. This allows the information processing device to determine whether or not a detected sound is a speech which a user intends. Therefore, it is possible to prevent a malfunction of falsely responding to a noise.

According to the above configuration, it is possible for the information processing device to control part of the microphones, which part includes one that has detected a sound determined as a noise, to be stopped. This makes it possible to continue attempting to detect a speech sound from a user with use of a microphone which has not detected a noise, while reducing a possibility that a noise is detected by a microphone. Therefore, it is possible to realize both (i) prevention of a malfunction and (ii) usability.

According to the above configuration, it is possible to omit an unnecessary process, such as a determining process or operation, which is carried out in a case where a noise is detected, by controlling a microphone, which has detected a sound determined as a noise, to be stopped. This allows a reduction in load imposed on the information processing device, and allows a reduction in unnecessarily consumed electric power. Thus, it is possible to prolong an operating time period of the information processing device.

The information processing device in accordance with a second aspect of the present invention can be arranged such that, in the first aspect, the speech sound obtaining section obtains, a plurality of times, the detected sounds detected by the respective microphones; and in a case where contents of speeches are not recognized, a given number of times in succession, from respective detected sounds detected by an identical one of the microphones, the noise determining section determines that the detected sounds are each a noise.

In a case where a sound from which a content of a speech is not recognized is detected repeatedly, it is highly possible that the sound is a noise. Therefore, according to the above configuration, it is possible to accurately determine whether or not a detected sound is a noise.

The information processing device in accordance with a third aspect of the present invention can be arranged such that, in the first or second aspect, each of the microphones is a microphone having directivity; said information processing device further includes a direction specifying section (direction specifying section 12) configured to specify, from the detected sounds detected by the respective microphones, directions in which the respective detected sounds have been uttered; and in a case where the noise determining section determines that a detected sound detected by any of the microphones is a noise, the detection control section controls at least one of the microphones, which at least one faces in a direction in which the detected sound has been uttered, to stop detecting a sound.

According to the above configuration, the information processing device specifies a direction in which a noise has been uttered, and controls at least one of the microphones, which at least one faces in the direction, to be stopped. This makes it possible to further reduce, from then on, a possibility that a noise is detected by a microphone.

The information processing device in accordance with a fourth aspect of the present invention can be arranged such that, in any one of the first through third aspects, in a case where (i) a content of a speech is recognized from a detected sound but (ii) the content of the speech does not correspond to a content of a response made by the output section, the noise determining section determines that the detected sound is a noise.

According to the above configuration, on the basis of whether or not a sound detected by a microphone indicates a content of a speech which content corresponds to a response made by the information processing device, the information processing device determines whether or not the sound is a noise. This allows the information processing device to determine whether or not a detected sound is a speech which a user intends. Therefore, it is possible to prevent a malfunction of falsely responding to a noise.

An electronic apparatus (interactive robot 1 or 2) in accordance with a fifth aspect of the present invention is an electronic apparatus including: the information processing device (control section 10) described in any one of the first through fourth aspects; the microphones (microphones 30); and the output section (speaker 40). According to the above configuration, it is possible to bring about an effect similar to that brought about by the information processing device in accordance with any one of the first through fourth aspects.

A method of controlling an information processing device in accordance with a sixth aspect of the present invention is a method of controlling an information processing device which recognizes a content of a speech and causes an output section to output a response corresponding to the content of the speech, the method including the steps of: (A) distinctively obtaining detected sounds from respective microphones, the detected sounds being ones that have been detected by the respective microphones (S10 and S42); (B) determining whether or not each of the detected sounds is a noise and, in a case where a content of a speech is not recognized from a detected sound, determining that the detected sound is a noise (S24 and S56); and (C) in a case where it is determined, in the step (B), that any of the detected sounds is a noise, controlling at least one of the microphones to stop detecting a sound (S26 and S58). According to the above process, it is possible to bring about an effect similar to that brought about by the information processing device in accordance with the first aspect.

The information processing device in accordance with each aspect of the present invention can be realized by a computer. The computer is operated based on (i) a control program for causing the computer to realize the information processing device by causing the computer to operate as each section (software element) included in the information processing device and (ii) a computer-readable storage medium in which the control program is stored. Such a control program and a computer-readable storage medium are included in the scope of the present invention.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 2 Interactive robot (electronic apparatus)
10 Control section (information processing device
11 Speech sound obtaining section
12 Direction specifying section
13 Character string converting section
14 Noise determining section
15 Response determining section
16 Output control section
17 Detection control section
20 Storage section
21 Response sentence table
22 Answer sentence table
30 Microphone
40 Speaker (output section)

1. An information processing device which recognizes a content of a speech and causes an output section to output a response corresponding to the content of the speech, comprising:
a speech sound obtaining section configured to distinctively obtain detected sounds from respective microphones, the detected sounds being ones that have been detected by the respective microphones;
a noise determining section configured to determine whether or not each of the detected sounds is a noise and configured to, in a case where a content of a speech is not recognized from a detected sound, determine that the detected sound is a noise; and
a detection control section configured to, in a case where the noise determining section determines that any of the detected sounds is a noise, control at least one of the microphones to stop detecting a sound.

2. The information processing device as set forth in claim 1, wherein:
the speech sound obtaining section obtains, a plurality of times, the detected sounds detected by the respective microphones; and
in a case where contents of speeches are not recognized, a given number of times in succession, from respective detected sounds detected by an identical one of the microphones, the noise determining section determines that the detected sounds are each a noise.

3. The information processing device as set forth in claim 1, wherein:
each of the microphones is a microphone having directivity;
said information processing device further comprises a direction specifying section configured to specify, from the detected sounds detected by the respective microphones, directions in which the respective detected sounds have been uttered; and
in a case where the noise determining section determines that a detected sound detected by any of the microphones is a noise, the detection control section controls at least one of the microphones, which at least one faces in a direction in which the detected sound has been uttered, to stop detecting a sound.

4. The information processing device as set forth in claim 1, wherein in a case where (i) a content of a speech is recognized from a detected sound but (ii) the content of the speech does not correspond to a content of a response made by the output section, the noise determining section determines that the detected sound is a noise.

5. An electronic apparatus comprising:
the information processing device recited in claim 1;
the microphones; and
the output section.

6. A method of controlling an information processing device which recognizes a content of a speech and causes an output section to output a response corresponding to the content of the speech, the method comprising the steps of:
(A) distinctively obtaining detected sounds from respective microphones, the detected sounds being ones that have been detected by the respective microphones;
(B) determining whether or not each of the detected sounds is a noise and, in a case where a content of a speech is not recognized from a detected sound, determining that the detected sound is a noise; and
(C) in a case where it is determined, in the step (B), that any of the detected sounds is a noise, controlling at least one of the microphones to stop detecting a sound.

7. A non-transitory computer-readable storage medium storing therein a control program for causing a computer to function as the information processing device recited in claim 1, the control program causing the computer to function as the speech sound obtaining section, the noise determining section, the detection control section.
